(19) United States
(12) Patent Application Publication
(10) Pub. No.: US 2008/0225311 A1
(43) Pub. Date: Sep. 18, 2008

(54) Image forming apparatus, image forming method and computer readable medium

(75) Inventors: Yoshifumi Bando, Kanagawa (JP); Nobukazu Miyoshi, Kanagawa (JP); Yoshiharu Yoshida, Kanagawa (JP); Masahiko Kikuchi, Kanagawa (JP); Nobuaki Suzuki, Kanagawa (JP); Kenichi Takahashi, Kanagawa (JP); Hideki Yamasaki, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 12/000,869

(22) Filed: Dec. 18, 2007

(30) Foreign Application Priority Data
Mar. 12, 2007 (JP) 2007-061882

(51) Int. Cl. G06F 15/00

(52) U.S. Cl. 358/1.9

(57) ABSTRACT

An image forming apparatus includes a combining unit, an image forming unit, a verification unit and a controller. The combining unit combines data from a first path and data from a second path. The image forming unit forms a combined image based on combined image data which is obtained by combining, by the combining unit, original image data from the first path and additional image data from the second path and which is transmitted through a third path. The verification unit verifies combined data which is obtained by combining, by the combining unit, verification data from the first path and verification data from the second path and which is transmitted through the third path. The controller detects, based on a verification result by the verification unit, falsification of data in the first path, the second path and the third path.

### CROSS-REFERENCE TO RELATED APPLICATIONS

This application is based on and claims priority under 35 U.S.C. §119 from Japanese Patent Application No. 2007-61882 filed Mar. 12, 2007.

### BACKGROUND

### Technical Field

The invention relates to an image forming apparatus, an image forming method and a computer-readable medium.

### SUMMARY

According to an aspect of the invention, an image forming apparatus includes a combining unit, an image forming unit, a verification unit and a controller. The combining unit combines data from a first path and data from a second path. The image forming unit forms a combined image based on combined image data which is obtained by combining, by the combining unit, original image data from the first path and additional image data from the second path and which is transmitted through a third path. The verification unit verifies combined data which is obtained by combining, by the combining unit, verification data from the first path and verification data from the second path and which is transmitted through the third path. The controller detects, based on a verification result by the verification unit, falsification of data in the first path, the second path and the third path.

### BRIEF DESCRIPTION OF THE DRAWINGS

Exemplary embodiments of the invention will be described in detail below with reference to the accompanying drawings, wherein:

FIG. 1 is a system configuration diagram showing one example of an image forming apparatus according to an exemplary embodiment of the invention;

FIG. 2 is a block diagram showing one example of a verification unit shown in FIG. 1;

FIG. 3 is a flow chart showing one example of an operation, in a verification mode, the image forming apparatus shown in FIG. 1;

FIG. 4 is a flowchart showing one example of the operation, in a normal mode, of the image forming apparatus shown in FIG. 1;

FIG. 5 is a flow chart showing one example of an operation of a supplemental verification unit of the image forming apparatus shown in FIG. 1;

FIG. 6 is a system configuration diagram showing an outline of another image forming apparatus according to another exemplary embodiment of the invention; and

FIG. 7 is a system configuration diagram showing an outline of still another image forming apparatus according to a still another exemplary embodiment of the invention.

### DETAILED DESCRIPTION

Hereinbelow, the exemplary embodiments of the invention will be described with reference to the drawings.

### (1) First Exemplary Embodiment

### (Configuration of First Exemplary Embodiment)

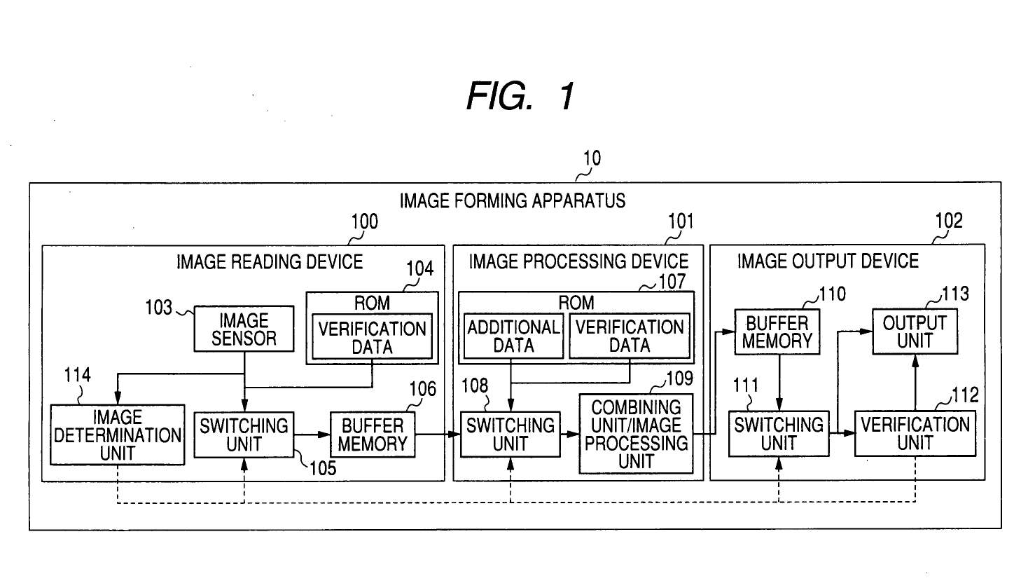

FIG. 1 shows one example of a block diagram of an image forming apparatus according to an exemplary embodiment of the invention. An image forming apparatus 10 has a copying function to obtain a copied material. The image forming apparatus 10 includes an image reading device 100, an image processing device 101, and an image output device 102.

The image reading device 100 is one example of a device for obtaining image data of an image. The image reading device 100 includes: an image sensor 103, which is an example of an image reader; ROM (read-only storage device) 104, an image determination unit 114, which is an example of a controller; a switching unit 105; and a buffer memory 106. The image sensor 103 includes a photoelectric conversion device having plural light receiving elements. In this exemplary embodiment, the image sensor 103 is used for the purpose of converting an original such as a paper document into image data. The ROM 104 is utilized as a storage medium for storing verification data, for original images, that has been prepared in advance. The verification data is data that is utilized for detecting falsification in transmission paths of image data. The verification data are output from the ROM 104 to the switching unit 105. The term “falsification” means that image data to be handled is changed by changing contents of data in the image reading device 100, in the image processing device 101, in the image output device 102 and/or in some midpoint of wiring lines connecting these devices, and/or by changing programs in these devices, which results in that an image having a different content from the original is formed.

An image determination unit 114 determines as to whether or not an image read by the image sensor 103 contains a copy prohibited image that has been set in advance. For example, the image determination unit 114 determines as to whether or not the image is an image of a printed matter which is copy prohibited, such as a bill, a stock certificate, and a title certificate. In the case where the image is that of a printed matter which is copy prohibited, the image determination unit 114 outputs a signal for notifying the switching unit 105 of the fact that copying of a copy prohibited image is being attempted. This determination is performed by storing images data of specific print contents in a storage unit of the image determination unit 114 and verifying as to whether or not image data that matches the stored image data is contained in the image data output from the image sensor 103.

The switching unit 105 receives the image data read by the image sensor 103 in a normal mode and sends it to the buffer memory 106. The switching unit 105 also reads verification data stored in the ROM 104 in a verification mode and sends it to the buffer memory 106. The switching unit 105 switches between the normal mode and the verification mode in accordance with a mode switching signal output from the verification unit 112.

The normal mode refers to an operation mode in which a normal printing process is performed and an operation mode in which an image combined with a predetermined additional image indicating, for example, “copy prohibited” is printed when an image which is copy prohibited is copied. It is noted that the phrase “copying is prohibited” refers to a state where copying is prohibited by laws, company regulations, and the like, or a state where copying is prohibited for user's personal reasons. Actual examples of the printed matter which is copy prohibited include bills and an address book of an organization. The additional image is an identification image for authentication or an identification image specifying a specific image. For example, images called “watermarks” are also one type of this additional image. The verification mode is an operation mode for detecting falsification of image data. The verification mode is executed at a predetermined timing that has been set in advance.

The buffer memory 106 is a storage medium utilized for the purpose of temporarily storing image data necessary for the operation. The buffer memory 106 may be constructed by a DRAM (Dynamic Random Access Memory), an SRAM (Static Random Access Memory), an EPROM (Erasable Programmable Read Only Memory), and a magnetic disk device, which are combined as appropriate.

The image processing device 101 has a function of combining the additional image data with an original image data read by the image reading device 100, and a function of combining verification data which is sent from the image reading device 100 and which had been stored in the ROM 104, with verification data stored in a ROM 107. The image processing device 101 includes the ROM 107, which is one example of a storage unit for storing the additional images data, a switching unit 108, and a combining unit/image processing unit 109.

The ROM 107 stores the additional data and the verification data. The additional data is image data that is a source of the predetermined additional images such as “copy prohibited.” The verification data is data that is utilized in verification for detecting falsification of image data. The verification data needs not be image data that constitutes an image that can be recognized visually but may be in any appropriate form that is suitable for verification of the data falsification.

In the normal mode, if copying of an image does not require adding of the additional data (if normal contents which is not copy prohibited is copied), the switching unit 108 reads the image data buffered in the buffer memory 106 and outputs it to the combining unit/image processing unit 109. In the normal mode, if copying of an image requires adding of the additional data (e.g., if a paper currency that is copy prohibited is copied), the switching unit 108 reads image data buffered in the buffer memory 106 and outputs it to the combining unit/image processing unit 109, and furthermore, the switching unit 108 reads the additional data stored in the ROM 107 and outputs it to the combining unit/image processing unit 109. In the verification mode, the switching unit 108 reads the verification data buffered in the buffer memory 106 and outputs it to the combining unit/image processing unit 109 and also, the switching unit 108 reads the verification data stored in the ROM 107 and outputs it to the combining unit/image processing unit 109.

The combining unit/image processing unit 109 has a function of combining the read image and the additional image based on the image data of the image read by the image sensor 103 and the additional data. The combining unit/image processing unit 109 also has a function of performing, for the image data of the image read by the image sensor 103, processes such as a conversion process into a predetermined data format, a color space conversion process for determining color scheme, a resolution conversion process for determining resolution, a filtering process for performing noise reduction and edge correction, and a screen process for converting into a data format that can be interpreted by the image output device 102. The combining unit/image processing unit 109 includes an ASIC (Application Specific Integrated Circuit) equipped with dedicated hardware.

The image output device 102 has a function of detecting falsification of image data and a function of printing out image data. In this exemplary embodiment, the image output device 102 has a buffer memory 110, a switching unit 111, the verification unit 112, and an output unit 113, which is one example of an image forming unit.

The buffer memory 110 is similar to the buffer memory 106, and temporarily stores image data necessary for the operation. In the normal mode, the switching unit 111 outputs the image data buffered in the buffer memory 110 to the output unit 113. In the verification mode, the switching unit 111 outputs the combined verification data buffered in the buffer memory 110 to the verification unit 112. The verification unit 112 has the function of detecting falsification of image data and a function of controlling operations related thereto. The verification unit 112 also has a function of controlling a process of combining the additional image with the read image. The output unit 113 has a printing device for forming and printing an image based on image data and a control device for controlling this printing device.

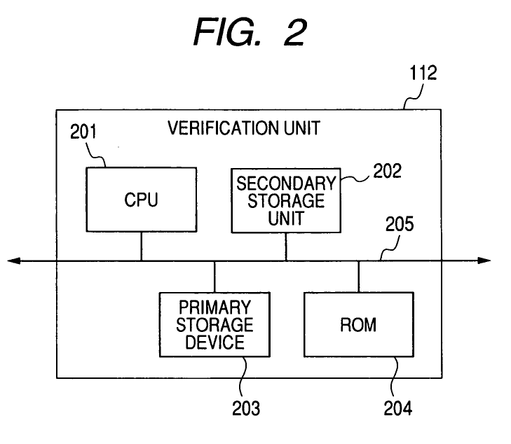

FIG. 2 shows one example of a block diagram of the verification unit 112 shown in FIG. 1. As shown in FIG. 2, the verification unit 112 includes a CPU 201, a secondary storage device 202, a primary storage device 203, a ROM 204, and an internal bus 205. The CPU 201 controls the operations performed by the verification unit 112 and the printing process for combining the additional data. One detailed example of each of these processes will be described later with reference to flow charts.

The secondary storage device 202 includes a magnetic disk device (harddisk device). The secondary storage device 202 retains a verification log and stores an operation program. The primary storage device 203 includes a RAM (Random Access Memory) and is used as a working area for verification programs executed by the CPU 201 and for necessary data read and wrote. The ROM 204 is used as a storage medium for storing, in advance, a hash value calculated from correct verification data.

The verification unit 112 detects as to whether or not there is falsification of data, using two pieces of the verification data stored in the ROM 104 (see FIG. 1) and the ROM 107, (see FIG. 1). In this exemplary embodiment, a unique value calculated from combined data of the two pieces of verification data is compared with a correct value that has been calculated in advance. Specifically, the verification unit 112 first acquires data (combined verification data) obtained by combining the two pieces of verification data stored in the ROM 104 and the ROM 107 and then, calculates a hash value using a predetermined hash function based on this combined verification data. It is detected as to whether or not there is falsification of data, by comparing this calculated hash value with a normal hash value of the combined verification data that has been stored in the ROM 204 in advance. SHA-1 (Secure Hash Algorithm 1) and MD5 (Message Digest Algorithm 5), for example, may be used as the hash function. In addition, when falsification is detected, a falsification detection signal is output through the internal bus 205 to the output unit 113. Upon reception of this signal, the output unit 113 executes a process (falsification notification process) of outputting a printed matter for notifying a user that falsification has been detected. In addition, the verification unit 112 also executes a process of prohibiting printing of an image that is combined with the additional image based on, the additional data stored in the ROM 107.

An example of function restriction process, which is one example of a function restriction unit, is a process for prohibiting individual functions such as printer and facsimile from being used. In addition, it is possible to execute a process for outputting an image that has been prepared in advance in place of the image data in which falsification has been detected (one example of a replacing unit). It may be preset whether or not these various processes are to be executed. In other words, the verification unit 112 may serve as a function restriction unit and/or a replacing unit.

### (Operation of First Exemplary Embodiment: Verification Mode)

Hereinbelow, one example of a verification process for detecting falsification of image data in the image forming apparatus 10 shown in FIG. 1 will be described. When the image reading device 100, the image processing device 101, and the image output device 102 are activated, a verification processing program stored in the secondary storage device 202 (see FIG. 2) is loaded into the primary storage device 203 first, and it is executed by the CPU 201. The verification processing program is executed at a time when the device is activated (power-on), a time of transition to a low power consumption mode, at a time when the image forming apparatus operates in the low power consumption mode, at a time of resuming from the low power consumption mode, at a preset time, at preset time intervals, every time a predetermined number of sheets or a predetermined amount of images are formed, at random timings determined using a random number generation program, and a timing determined using a combination of these factors.

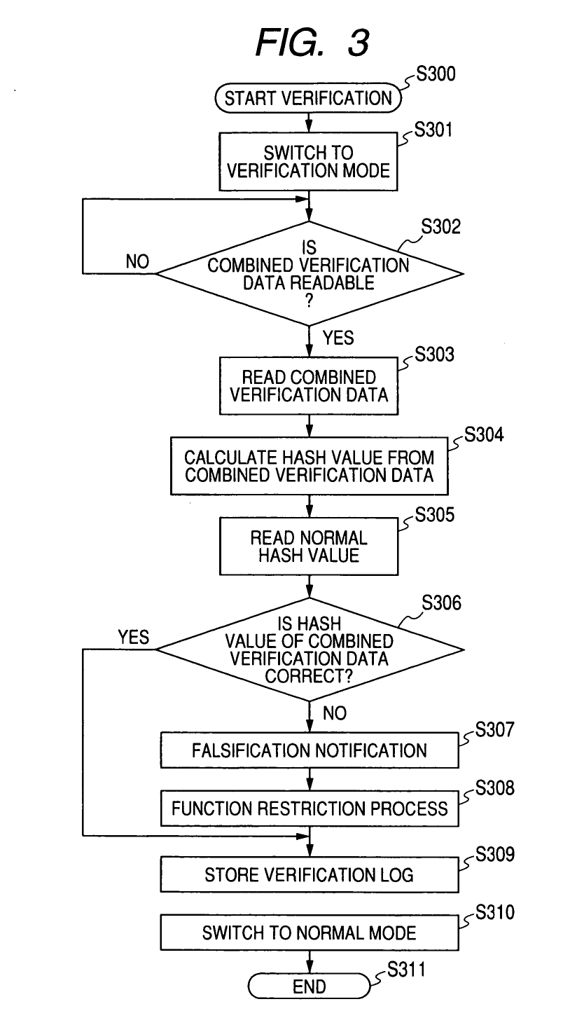

FIG. 3 is a flow chart showing one example of a procedure of this verification process. Upon start of the verification (step S300), first, a process for switching the operation mode to the verification mode is performed at step S301. This process is executed by transmitting a mode switching signal from the verification unit 112 (see FIG. 1) to the switching unit 105, the switching unit 108 and the switching unit 111. Upon receipt of the mode switching signal, the switching unit 105 reads first verification data stored in the ROM 104, writes the first verification data into the buffer memory 106, and simultaneously prohibits a scanning request. Upon receipt of the mode switching signal, the switching unit 109 requests the first verification data (the verification data stored in the ROM 104) to the image reading device 100, reads second verification data stored in the ROM 107, and outputs the two pieces of verification data to the combining unit 109. The combining unit 109 combines the two pieces of verification data to output combined verification data, and outputs the combined verification data to the image output device 102. This combined verification data is stored in the buffer memory 110.

Next, the process proceeds to step S302, at which it is determined as to whether or not there is a combined verification data in the buffer memory 110 and whether or not the combined verification data is readable. If the combined verification data is readable, the combined verification data is read into the primary storage device 203 (see FIG. 2) (step S303). A hash value is calculated from the combined verification data using the predetermined hash function (step S304). Then, the process proceeds to step S305. Alternatively, if the combined verification data is unreadable, step S302 is executed again.

In the step S305, the normal hash value of the combined verification data is read from the ROM 204. Then, a verification process is executed by comparing the hash value of the combined verification data calculated at the step S304 and the normal hash value read at the step S305 and verifying as to whether or not the two hash values match (step S306). If the two hash values match, it is determined that the combined verification data is correct, and the process proceeds to step S309.

If the two hash values do not match, falsification notification is performed (step S307). The falsification notification is performed by outputting, from the output unit 113, the printed matter indicating that data is falsified. It is noted that there are three transmission paths in which data may be falsified: the first path is from the image sensor 103 to the combining unit/image processing unit 109, the second path is from the ROM 107 storing the additional data to the combining unit/image processing unit 109, and the third path is from the combining unit/image processing unit 109 to the output unit 113. In these transmission paths, there is a risk that data may be falsified by changing a signal line or altering a program.

In addition, a function restriction process is executed (step S308). Once the function restriction process is executed, the function of printing a copy-prohibited original image combined with the additional image becomes disabled. It is noted that even while the function restriction process is executed, normal printing (that is, copying) can be carried out if the image acquired by the image sensor 103 is an image of a printed matter that is not copy-prohibited.

Next, a log of the verification result is stored in the secondary storage device 202 (step S309). Then, a mode switching signal for switching the operation mode from the verification mode to the normal mode is sent to the switching unit 105, the switching unit 108, and the switching unit 111 (step S310), and the verification processing program terminates (step S311).

### (Operation of First Exemplary Embodiment: Normal Mode)

Hereinbelow, one example of the process of the normal mode will be described. The normal mode includes: (1) the case of printing a copy of an original image that is not copy prohibited (normal copying) and (2) the case where, when printing a copy of an original image that is copy prohibited, an additional image indicating a message such as “printing prohibited” is combined with the copied material so that a user can clearly recognize that the obtained copy is a copy-prohibited printed matter.

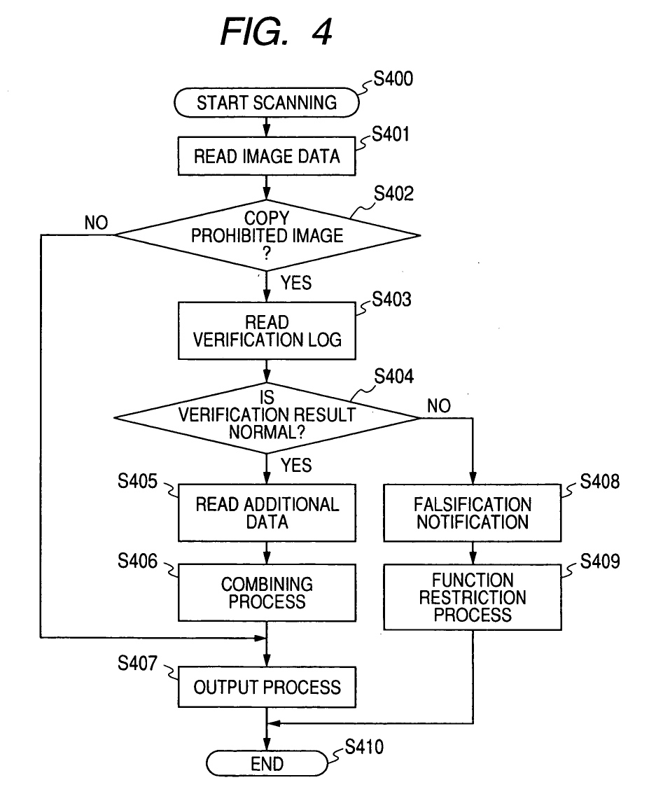

FIG. 4 is a flowchart showing one example of the processing procedure in the normal mode. The program for executing the process shown in FIG. 4 is stored in the secondary storage device 202 shown in FIG. 2. The program is loaded into the primary storage device 203 and executed by the CPU 201.

When the image sensor 103 (see FIG. 1) starts to scan an original image to be copied (step S400), image data that is output from the image sensor 103 is read into the image determination unit 114 of FIG. 1 (step S401). Then, it is determined as to whether or not the image read by the image sensor 103 is a copy prohibited image (step S402). Also, the switching unit 105 reads the image data from the image sensor 103 and outputs it to the buffer memory 106.

If the read image is not a copy prohibited image, printing is carried out based on the image data of the original image that has been read by the image sensor 103 (step S407). That is, the image data stored in the buffer memory 106 is sent to the image processing device 101. Then, image processing necessary for the copying process is executed, and the image data is further sent to the image output device 102, in which an output process (printing process) is performed.

If the image is a copy prohibited image, the image determination unit 114 first reads the verification log stored in the secondary storage device 202 of the verification unit 112 (step S403) and determines as to whether or not the verification result recorded in the verification log is normal (step S404).

If the verification result is normal, the switching unit 108 reads the additional data (such as image data used to combine an image of “copy prohibited”) in the ROM 107 (step S405) and outputs it to the combining unit/image processing unit 109. Also, the switching unit 108 reads the image data of the original image stored in the buffer memory 106 and outputs the image data to the combining unit/image processing unit 109. The combining unit/image processing unit 109 combines the image data of the original image with the additional data to generate image data of the combined image (step S406).

The combining unit/image processing unit 109 carries out image processing, which is necessary for the copying process, for the image data of the combined image and outputs the processed data to the buffer memory 110. The output unit 113 executes the output process (printing process) based on this image data (step S407), and the process terminates (step S410).

If the verification result recorded in the verification log is not normal in the determination process at step S404, the output unit 113 performs falsification notification of printing a printed matter indicating that the data has been falsified (step S408), and the function restriction process is executed (step S409). Thereby, a function of printing a copy-prohibited original image combined with an additional image becomes disabled. Next, the process terminates (step S410).

It is of course possible to provide the program for executing the processes shown in FIGS. 3 and 4 through a communication device or to provide the program stored in a storage medium such as a CD-ROM.

### (2) Second Exemplary Embodiment

In the first exemplary embodiment, header information of the image data may be used as a method for controlling the switching unit. For example, in steps S301 and S310 shown in FIG. 3, data for identifying the verification mode or the normal mode is embedded into the header information of the image data, instead of transmitting the mode switching signal to the plural switching units. The switching unit 105, the switching unit 108 and the switching unit 111 carry out mode switching based on the header information of the image data. For example, this method is suitable when the image reading device 100 and the image processing device 101 are located at distance places relative to each other or the image processing device 101 and the image output device 102 are located at distance places relative to each other. This is because the mode can be switched using the header information of the image data.

### (3) Third Exemplary Embodiment

In the operation of the first exemplary embodiment, it may be examined as to whether or not the verification for detecting data falsification is executed at a preset timing during the operation of the image forming apparatus 10. If the verification is not performed at the preset timing, such a fact may be notified and a process for restricting a function (one example of a supplemental verification unit) may be executed. One example of this exemplary embodiment will be described below.

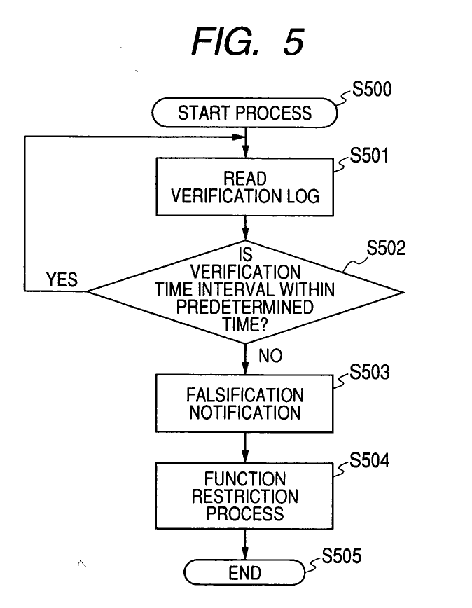

FIG. 5 is a flow chart showing one example of the process procedure described in this exemplary embodiment. The program for executing the process shown in FIG. 5 is stored in the secondary storage device 202. The program is loaded into the primary storage device 203 and executed by the CPU 201.

When the main power supply of the image forming apparatus 10 shown in FIG. 1 is turned on, the process is started (step S500). At first, the verification log is read (step S501). Next, based on the verification log, it is verified as to whether or not the time interval between verification (the process shown in FIG. 3) and another verification is within a predetermined time. For example, when the process shown in FIG. 3 is set to be executed once per 1 hour while the image forming apparatus 10 is being operated, it is verified, at step S502, as to whether or not the interval between execution times recorded in verification record of the verification log is within 1 hour.

If the determination result at step S502 is NO, the falsification notification (step S503) and the function restriction process (step S504) are executed because it is concerned that the setting regarding the execution timing of the process shown in FIG. 3 is falsified. Then, the process is terminated (step S505). On the other hand, if the determination result at step S502 is YES, the process at step S501 is repeated.

The same process as in step S307 shown in FIG. 3, for example, may be used as the falsification notification in step S503. In addition, the same process as in step S308 shown in FIG. 3, for example, may be used as the function restriction process in step S504.

### (4) Fourth Exemplary Embodiment

As the function restriction process of step S308 of FIG. 3, an image having such contents that the occurrence of a falsification action can be easily recognized when a copy prohibited printed matter is copied. In this case, a non-volatile memory that stores image data of a predetermined image is provided in the output unit 113, and the printing is carried out using the image data stored in this non-volatile memory. As a setting of the function restriction process, a supplied blank paper sheet may be output as it is, without anything being printed thereon. Alternatively, print data part of which is missing may be printed out so that the occurrence of falsification action can be easily recognized.

### (5) Fifth Exemplary Embodiment

As the falsification notification of step S307 of FIG. 3, a user may be informed of information indicating that a falsification action is happening. In this case, a display device (such as a liquid crystal display), which is not shown in the drawings, is provided in the image forming apparatus 10 shown in FIG. 1. Based on the determination result of the verification unit 112, this display device displays a massage for informing the user of the occurrence of falsification (a message such as “Warning: data falsification might be taking place internally”). In addition, a sound generator device may be provided in the image forming apparatus 10 shown in FIG. 1 so that appropriate alarm sound is generated at the same time as displaying of the message.

In addition, a communication interface (not shown) may be provided in the image forming apparatus 10 shown in FIG. 1 so that the occurrence of the data falsification activity is transmitted outside. For example, a communication interface that is capable of connecting to the Internet service line may be provided so that when data falsification is detected, transmitted is an e-mail for notifying a system administrator or a maintenance vendor that data falsification has been detected.

### (6) Sixth Exemplary Embodiment

### (Configuration of Sixth Exemplary Embodiment)

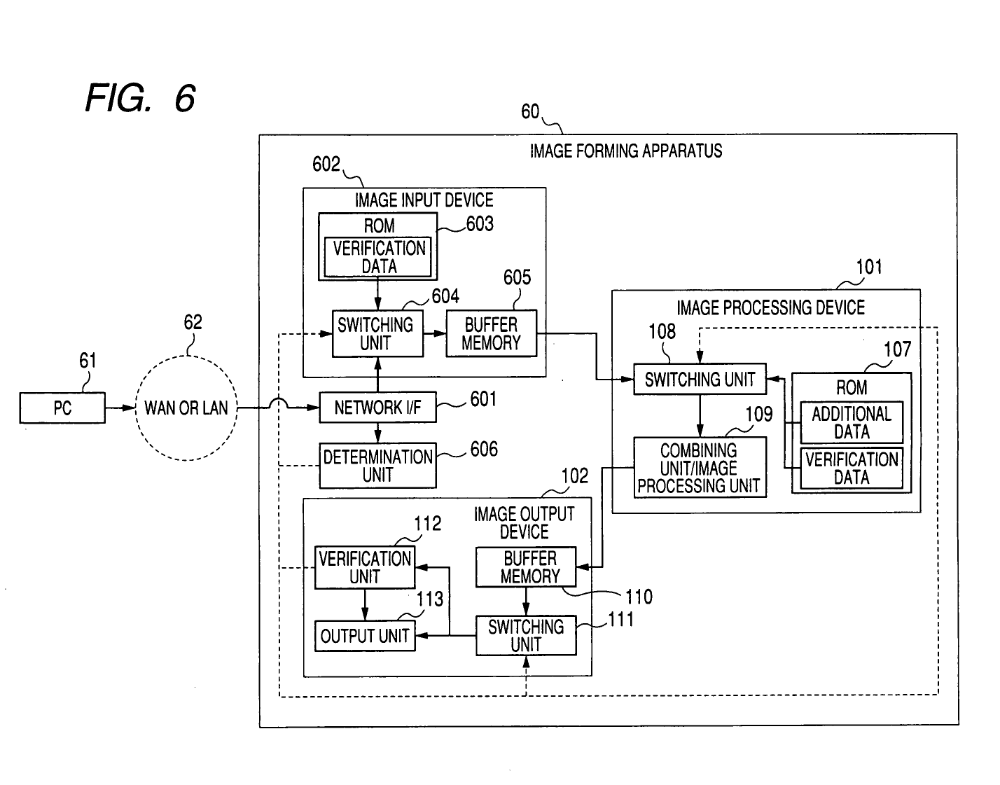

The invention may also be used in an image forming apparatus for printing image data stored in a terminal such as a personal computer. FIG. 6 is a block diagram of one example of an image forming apparatus having a printing function according to this exemplary embodiment of the invention. An image forming apparatus 60 shown in FIG. 6 has the function of printing out image data sent from a PC (personal computer) 61 through WAN (Wide Area Network) or LAN (Local Area Network) 62.

The image forming apparatus 60 shown in FIG. 6 includes a network I/F (interface) 601, a determination unit 606, an image input device 602, an image processing device 101 and an image output device 102. The network I/F (interface) 601 has an interface function to carry out communication through a communication unit such as WAN or LAN 62. The image input device 602, which is one example of an image input unit, acquires image data received by the network I/F 601 and sends it to the image processing device 101. Also, the image input device 602 sends verification data to the image processing device 101. The image processing device 101 and the image output device 102 are the same as those shown in the first exemplary embodiment (see FIG. 1).

The determination unit 606 refers to header information of the received image data and determines as to whether or not the received image data requires adding of an additional image. For example, it determines as to whether or not there is identification information of “confidential” in the header information of the image data that the PC 61 has requested to print. If there is the identification information of “confidential,” the image data is combined with image data of a message “confidential” and is printed out.

The image input device 602 includes a ROM 603, a switching unit 604 and a buffer memory 605. The ROM 603 stores the verification data. The switching unit 604 is controlled by the verification unit 112. In the normal mode, the switching unit 604 outputs the image data received by the network I/F 601 to the buffer memory 605. In the verification mode, the switching unit 604 reads the verification data stored in the ROM 603 and outputs it to the buffer memory 605.

### (Operation of Sixth Exemplary Embodiment: Verification Mode)

In the verification mode, at first, the verification data stored in the ROM 603 is read into the switching unit 604 and is sent to the buffer memory 605. The verification data sent to the buffer memory 605 is read into the switching unit 108 and is sent to the combining unit/image processing unit 109.

Meanwhile, the switching unit 108 reads the verification data stored in the ROM 107 and sends it to the combining unit/image processing unit 109. The combining unit/image processing unit 109 combines the verification data stored in the ROM 603 and the verification data stored in the ROM 107 to generate combined verification data, and sends it to the buffer memory 110. The switching unit 111 reads the combined verification data stored in the buffer memory 110 and sends it to the verification unit 113. The verification unit 113 compares a hash value of the combined verification data with the normal hash value of the combined verification data that has been stored in the ROM 204 (see FIG. 2) in advance, to verify as to whether or not data falsification occurs.

If data falsification is detected in the image forming apparatus 60, a function restriction process is executed. For example, the function of printing an image with which an additional image of characters “confidential” is combined becomes disabled.

### (Operation of Sixth Exemplary Embodiment: Normal Mode)

Hereinbelow, one example of the process of the normal mode will be described. As in the first exemplary embodiment, the normal mode includes: (1) the case of printing image data that is not copy prohibited (normal copying) and (2) the case where, when image data that is copy prohibited is printed, an additional image of a message such as “printing prohibited” is combined with the copied material so that a user can clearly recognize that the obtained copy is a copy-prohibited printed matter. The program for executing this operation is the same as that in FIG. 3.

When the image data is received from the PC 61 by the network I/F 601, the determination unit 606 determines as to whether or not there is identification information “confidential” in the header information of the image data. Then, a switching signal for the normal mode is output to the switching unit 604, the switching unit 108, and the switching unit 111. Upon receipt of the switching signal, the switching unit 604 outputs the image data received by the network I/F 601 to the image processing device 101 via the buffer memory 605.

If the image is not a copy prohibited image, printing is carried out based on the image data received by the network I/F 601. That is, the image data stored in the buffer memory 106 is sent to the image processing device 101, in which image processing necessary for the copy processing is performed, and the image data is further sent to the image output device 102, in which output processing (printing process) is performed.

If the image is a copy prohibited image, the image determination unit 606 first reads the verification log stored in the secondary storage device 202 of the verification unit 112 and determines as to whether or not the verification result recorded in the verification log is normal.

If the verification result is normal, the switching unit 108 reads the additional data including the image of the message “confidential,” and outputs it to the combining unit/image processing unit 109. In addition, the switching unit 108 reads the image data stored in the buffer memory 605 and outputs it to the combining unit/image processing unit 109. The combining unit/image processing unit 109 combines the image data with the additional data to generate image data of a combined image.

The combining unit/image processing unit 109 carries out image processing, which is necessary for the copy process, for the image data of the combined image and outputs the processed data to the buffer memory 110. The output unit 113 carries out the output process (printing process) based on this image data.

If the verification result recorded in the verification log is not normal, the output unit 113 performs falsification notification of printing a printed matter indicating that the data has been falsified, and the function restriction process is executed. Thereby, a function of printing a copy-prohibited original image combined with an additional image becomes disabled.

### (7) Seventh Exemplary Embodiment

### (Configuration of Seventh Exemplary Embodiment)

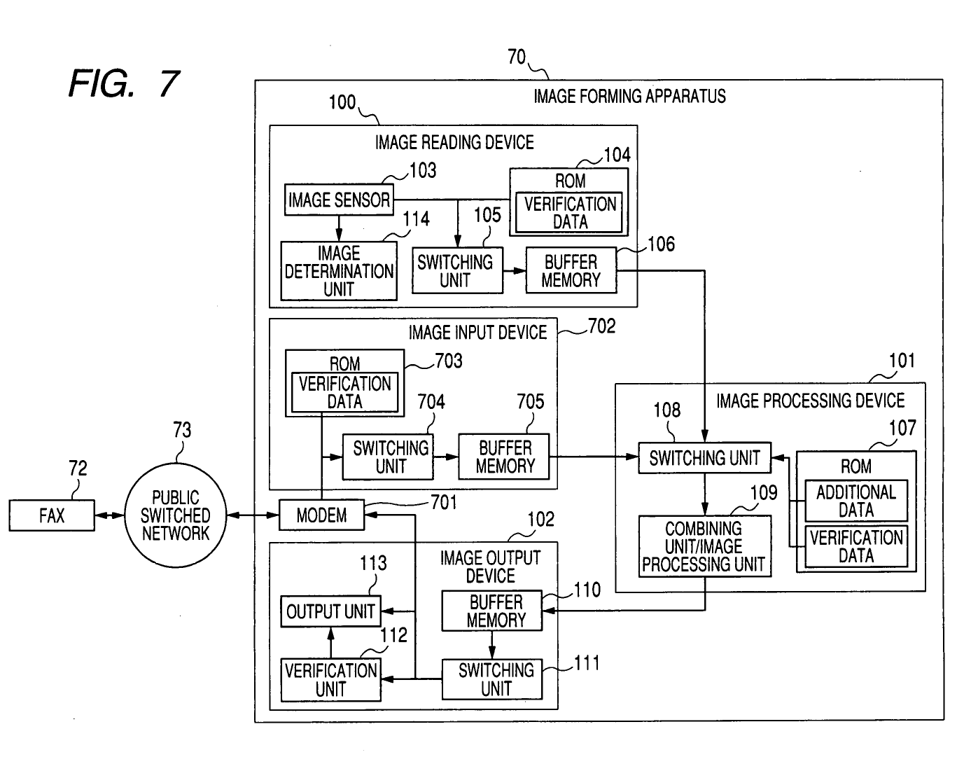

This exemplary embodiment illustrates an example in which the invention is utilized in a multifunctional machine having a copying function and a facsimile communication function. FIG. 7 is a block diagram showing one example of an image forming apparatus according to this exemplary embodiment. An image forming apparatus 70 shown in FIG. 7 is provided with a modem 701 for performing facsimile communication. The modem 701 is connected to a public switched network (generally a telephone network) 73 and is capable of facsimile communication with another facsimile communication device 72, which is likewise connected to the public switched network 73. The image forming apparatus 70 includes an image reading device 100, an image processing device 101, and an image output device 102. These devices have the same configurations as those shown in FIG. 1 and have the same functions.

The image forming apparatus 70 has an image input device 702. The image input device 702 is one example of a device to which an image is input, and has a function of acquiring image data received through facsimile communication thereinto. The image input device 702 includes a ROM 703, a switching unit 704 that stores verification data, and a buffer memory 705.

In the verification mode, the switching unit 704 reads the verification data stored in the ROM 703, and outputs it to the buffer memory 705. In the normal mode, the switching unit 704 receives data of a facsimile image that is output from the modem 701 and outputs it to the buffer memory 705.

Although a signal path is not shown in the drawing, the switching unit 105, the switching unit 108, the switching unit 111 and the switching unit 704 have the function of switching between the normal mode and the verification mode, using a mode switching signal input from the verification unit 112. The image determination unit 114 outputs the determination result to the verification unit 112. In addition, the modem 701 is capable of receiving a signal for prohibiting facsimile transmission, from the verification unit 112.

The image forming apparatus of this exemplary embodiment has the function of combining an additional image of a message such as “confidential information, handle with care” with the facsimile image to be transmitted if an attempt is made to send an original document which contains confidential information by facsimile transmission, in addition to the function of combining the additional image if a copy prohibited original is copied as described in the first exemplary embodiment. In addition, the image forming apparatus 70 according to this exemplary embodiment has the function of detecting data falsification in a transmission path when the additional image is combined.

### (Operation of Seventh Exemplary Embodiment: Verification Mode)

The operation of the verification mode is basically similar to the process shown in FIG. 3. What is different from the first exemplary embodiment is that there are two first paths through which the original image is transmitted. Specifically, a difference is that the verification for detecting as to whether or not there is data falsification is performed in a path: the modem 701=>the combining unit/image processing unit 109 (the second one of the first paths) as well as in the path: the image sensor 103=>the combining unit/image processing unit 109 (the first one of the first paths). Moreover, another difference is that the function restriction process for disabling the facsimile function is executed if data falsification is detected.

In this exemplary embodiment, the process shown in FIG. 3 is executed in each of the two paths. Since the verification in the first one of the first paths has already been described in the first exemplary embodiment, one example of the verification in the second one of the first paths will be described below. In the verification in the second one of the first paths, at first, the verification data is read into the switching unit 704 from the ROM 703 of the image input device 702. Then, the read verification data is sent to the image processing device 101 via the buffer memory 705. This verification data is sent from the switching unit 108 to the combining unit/image processing unit 109.

Meanwhile, the switching unit 108 reads the verification data stored in the ROM 107 and sends it to the combining unit/image processing unit 109. The combining unit/image processing unit 109 combines the verification data stored in the ROM 703 and the verification data stored in the ROM 107 to generate combined verification data. This combined verification data is sent to the buffer memory 110 and is sent from the switching unit 111 to the verification unit 112. The verification unit 112 calculates a hash value of this combined verification data and compares it with the normal hash value that has been calculated and stored in the ROM 204 in advance (see FIG. 2), to verify as to whether or not there is data falsification.

If data falsification is detected in the transmission path inside the image forming apparatus 70, the function restriction process is executed. In this example, as the function restriction process, a control signal for restricting an operation is sent from the verification unit 112 to the output unit 113 so as to prohibit outputting of the combined image in which an additional image based on the additional data stored in the ROM 107 is combined. In addition, a control signal for prohibiting facsimile transmission is sent from the verification unit 112 to the modem 701 so as to prohibit facsimile transmission of the combined image in which the additional data stored in the ROM 107 is combined.

### (Operation of Seventh Exemplary Embodiment: Normal Mode (In Case of Copying))

The copying operation using the image forming apparatus 70 is the same as in the case of the first exemplary embodiment.

### (Operation of Seventh Exemplary Embodiment: Normal Mode (In Case of Facsimile Reception))

When facsimile communication data is transmitted from the facsimile device 72 to the image forming apparatus 70 via the public switched network 73, the data is received at the modem 701. The facsimile communication data received at the modem 701 is converted from a voice band signal into a digital signal and is further data-expanded to form an image data.

The image data demodulated by the modem 701 is sent to the image input device 702, and is then sent therefrom to the image processing device 101. The image processing device 101 carries out predetermined image processing for this image data. The image data processed by the combining unit/image processing unit 109 is sent to the image output device 112 and is then output (printed out) from the output unit 113.

### (Operation of Seventh Exemplary Embodiment: Normal Mode (in Case of Facsimile Transmission))

In the case of transmitting a facsimile image, at first, an image of a transmission original is read by the image sensor 103 of the image reading device 100. The original image read by the image sensor 103 is sent through the switching unit 105 and the buffer memory 106 to the image processing device 101 as image data. The image determination unit 114 checks the read contents so that if image contents that require combining of an additional image is read, the image determination unit 114 transmits a signal notifying as such to the verification unit 112.

If the image read by the image reading device 100 is an image that does not require combining of an additional image, the image data image-processed by the image processing device 101 is sent to the image output device 102 and is sent therefrom to the modem 701. The modem 701 compresses this image data, converts it into a voice band signal, and outputs it to the public switched network 73.

If the image read by the image reading device 100 is an image that requires combining of an additional image, image data of a combined image in which the image is combined with the additional image is generated by the image processing device 101. The image data of this combined image is sent to the image input device 102, and is sent therefrom to the modem 701. The modem 701 compresses this image data, converts it into a voice band signal, and outputs it to the public switched network 73. In this case, the facsimile image that is output to the public switched network 73 is such that the additional image of a message such as “Confidential information, Handle with Care” is displayed over the original image.

On the other hand, if data falsification is detected in a transmission path inside the image forming apparatus 70 based on the verification log that is output from the verification unit 112, a function restriction process is executed. Specifically, transmission of the combined image data from the modem is prohibited, so no combined image data in which the additional image is combined with the original image read by the image reading device 100 is facsimile-transmitted.

### Modified Example of Verification Mode

In the verification mode of the image forming apparatus 70 shown in FIG. 7, combined data may be used in which the verification data from the image reading device 100, the verification data from the image input device 702, and the verification data from the image processing device 101 are combined.

### (8) Eighth Exemplary Embodiment

In the seventh exemplary embodiment, a facsimile image of a predetermined content that has been prepared in advance may be used instead of not facsimile transmitting the facsimile image in which the additional image is combined (one example of the replacing unit). For example, a facsimile image having a content that “Facsimile Image Cannot Be Transmitted Due To A Problem” may be transmitted when the function restriction process is executed.

### (9) Ninth Exemplary Embodiment

The function restriction processes of FIGS. 3 to 5 may be such a process that the image forming apparatus 10 (see FIG. 1) is set not to operate. In other words, the image forming apparatus 10 may be made unusable if data falsification is detected in the transmission paths inside the image forming apparatus 10.

Alternatively, in the seventh exemplary embodiment, if data falsification is not detected in the path: the image reading device 100=>the image processing device 101 (the first one of the first paths) but data falsification is detected in the path: the input device 702=>the image processing device 101 (the second one of the first paths), only the facsimile function may be restricted without restricting the copying function. In this case, the verification unit 112 sends a control signal of the function restriction process to the modem 701 so that the modem 701 is inhibited from transmission and reception of facsimile data.

Alternatively, in the seventh exemplary embodiment, if data falsification is detected in the path: the image reading device 100=>the image processing device 101 (the first one of the first paths) but data falsification is not detected in the path: the input device 702=>the image processing device 101 (the second one of the first paths), only the copying function may be restricted and the facsimile function may be allowed to function.

### (10) Tenth Exemplary Embodiment

Although FIG. 3 shows an example in which it is determined using a hash value as to whether or not there is data falsification, it may be determined as to whether or not there is data falsification without using a hash value. In this case, referring to the example of FIG. 1, combined verification data in which the verification data stored in the ROM 104 and the verification data stored in the ROM 107 are combined is stored in the ROM 204 (see FIG. 2) in advance. Then, in the verification process, the combined verification data combined by the combining unit/image processing unit 109 and the combined verification data stored in the ROM 204 are compared bit by bit as they are to determine as to whether or not there is data falsification.

### (11) Eleventh Exemplary Embodiment

In the image forming apparatus shown in FIGS. 1, 6, and 7, such a configuration may be adopted that the output unit 113 of the image output portion 102 does not carry out printing of images but outputs image data that forms a basis of printing. In this case, a printing device for carrying out printing is provided outside, and the output unit 113 outputs the image data to the external printing device.

### (12) Twelfth Exemplary Embodiment

The number of pieces of the verification data to be combined may be three or more. For example, in the first exemplary embodiment, a second combining unit may be provided in the image output device 102, and third verification data may be combined with the combined verification data output from the combining unit/image processing device 109. In this case, the verification data stored in the ROM 104, the verification data stored in the ROM 107, and the third verification data are combined, and validity of the combined verification data is determined in the verification unit 112.

### (13) Thirteenth Exemplary Embodiment

The verification data may be automatically generated each time it is used, without using the verification data stored in the memory. In the first exemplary embodiment, for example, a generation program for verification data may be stored in the ROM 104. Then, when the verification data is required, a CPU (or a dedicated circuit), which is not shown in the drawing, executes the generation program for verification data to generate verification data. At the same time, the verification unit 112 generates combined verification data, which serves as a reference for the verification, based on the program stored in a ROM each time the verification process is executed. In this case, it is determined as to whether or not there is data falsification by comparing a hash value of the combined verification data that serves as the reference of the verification and a hash value of the combined verification data output from the image processing device 101.

### (14) Fourteenth Exemplary Embodiment

For example, a computer terminal, a server, or a board that comprises the image input device 702, the image processing device 101, and the image output device 102 shown in FIG. 7 may be configured. In this case, the output unit 113 does not have a printing function and serves as a data output device for outputting print data.

The invention may be applied to an image forming apparatus that detects data falsifications in the transmission paths inside the image forming apparatus, which combines an original image with an additional image.

The foregoing description of the exemplary embodiments of the invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a combining unit that combines data from a first path and data from a second path;
an image forming unit that forms a combined image based on combined image data which is obtained by combining, by the combining unit, original image data from the first path and additional image data from the second path and which is transmitted through a third path;
a verification unit that verifies combined data which is obtained by combining, by the combining unit, verification data from the first path and verification data from the second path and which is transmitted through the third path; and
a controller that detects, based on a verification result by the verification unit, falsification of data in the first path, the second path and the third path.

2. The image forming apparatus according to claim 1, further comprising:
an image reader that reads an image; and
a storage unit that stores the additional image data, wherein
the first path is a data transmission path between the combining unit and the image reader,
the second path is a data transmission path between the combining unit and the storage unit, and
the third path is a data transmission path between the combining unit and the image forming unit.

3. The image forming apparatus according to claim 1, wherein the verification unit verifies the combined data by comparing a unique value with a normal value that is calculated in advance, the unique value being calculated from the combined data.

4. The image forming apparatus according to claim 1, further comprising:
a function restriction unit that restricts, based on the verification result by the verification unit, a function of forming the combined image by the image forming unit.

5. The image forming apparatus according to claim 1, further comprising:
an image replacing unit that replaces, based on the verification result by the verification unit, the combined image data with predetermined image data that is prepared in advance.

6. The image forming apparatus according to claim 1, further comprising:
a supplemental verification unit that supplementarily verifies as to whether or not a time interval between verifications performed by the verification unit is within a predetermined time; and
a second function restriction unit that restricts, based on a verification result by the supplemental verification unit, a function of forming the combined image by the image forming unit.

7. A computer-readable medium storing a program causing a computer to execute a data verification process, the data verification process comprising:
combining verification data from a first path and verification data from a second path to generate combined data;
transmitting the combined data through a third data path;
verifying the combined data transmitted through the third path; and
detecting, based on a verification result, falsification of data in the first path, the second path and the third path.

8. The computer-readable medium according to claim 7, wherein the data verification process further comprising:
calculating a unique value from the combined data transmitted through the third path; and
comparing the calculated unique value with a normal value that is calculated in advance.

9. The computer-readable medium according to claim 7, wherein the data verification process further comprising:
combining original image data from the first path and additional image data from the second path to generate a combined image;
transmitting the combined image data through the third path; and
restricting, based on the verification result, forming the combined image based on the combined image data which transmitted through the third path on a recording medium.

10. The computer-readable medium according to claim 7, wherein the data verification process further comprising:
combining original image data from the first path and additional image data from the second path to generate combined image data;
transmitting the combined image data through the third path; and
replacing, based on the verification result, the combined image data transmitted through the third path with predetermined image data that is prepared in advance.

11. The computer-readable medium according to claim 7, wherein the data verification process further comprising:
combining original image data from the first path and additional image data from the second path to generate combined image data;
transmitting the combined image data through the third path;
supplementarily verifying as to whether or not a time interval between the verifyings of the combined data is within a predetermined time; and
restricting, based on a result of the supplementarily verifying, forming the combined image based on the combined image data which transmitted through the third path on a recording medium.

12. An image forming method comprising:
combining data from a first path and data from a second path;
forming a combined image based on the combined image data which is obtained by combining original image data from the first path and additional image data from the second path and which is transmitted through the a third path;
verifying combined data which is obtained by combining, verification data from the first path and verification data from the second path and which is transmitted through the third path; and
detecting, based on a verification result, falsification of data in the first path, the second path and the third path.

13. The image forming method according to claim 12, wherein the combined data is verified by comparing a unique value with a normal value that is calculated in advance, the unique value being calculated from the combined data.

14. The image forming method according to claim 12, further comprising:
restricting, based on the verification result, a function of forming the combined image.

15. The image forming method according to claim 12, further comprising:
replacing, based on the verification result, the combined image data with predetermined image data that is prepared in advance.

16. The image forming method according to claim 1, further comprising:
supplementarily verifying as to whether or not a time interval between verifications is within a predetermined time; and
restricting, based on a supplemental verification result, a function of forming the combined image.
